(19) United States
(12) Patent Application Publication
(10) Pub. No.: US 2026/0109200 A1
(43) Pub. Date: Apr. 23, 2026

(54) AIR-CONDITIONING SYSTEM AND METHOD FOR DEHUMIDIFYING AN AIR-CONDITIONING SYSTEM

(71) Applicants: DR. ING. H.C. F. PORSCHE AG, Stuttgart (DE); AUDI AG, Ingolstadt (DE)

(72) Inventors: Michael AUGULL, Holzgerlingen (DE); Dominic HERRMANN, Mössingen (DE); Andreas STÖCKLEIN, Kösching (DE)

(73) Assignees: DR. ING. H.C. F. PORSCHE AG, Stuttgart (DE); AUDI AG, Ingolstadt (DE)

(21) Appl. No.: 19/120,043

(22) PCT Filed: Oct. 5, 2023
(86) PCT No.: PCT/EP2023/077608

§ 371 Date: Apr. 10, 2025

(30) Foreign Application Priority Data
Oct. 12, 2022 (DE) 10 2022 126 617.6

(51) Int. Cl. B60H 1/32

(52) U.S. Cl. CPC B60H 1/3233; B60H 1/3229

(57) ABSTRACT

An air-conditioning system, in particular for the climate control of an interior of a motor vehicle, includes a fan for conveying drawn-in air through an air duct and having an evaporator, provided in the air duct, for cooling the drawn-in air. A collecting body, separate from the air duct, for collecting air humidity, condensed at the evaporator, of the drawn-in air is provided in the air duct. In the deactivated state of the evaporator, the drawn-in air is able to flow against and/or around the collecting body. As a result of the collecting body being positioned within the air duct, it is possible to improve discharging of condensate that arises at the evaporator, such that easy and efficient dehumidification of an air-conditioning system is made possible.

### FIELD

The invention relates to an air-conditioning system with which an interior of a motor vehicle can be air-conditioned, as well as to a method with which such an air-conditioning system can be dehumidified.

### BACKGROUND

From DE 10 2005 022 208 A1 it is known to let a fan of an air-conditioning system of the motor vehicle continue to run after a motor vehicle has been switched off and to guide the air flow of the fan along a lowest point of an air duct of the air-conditioning system in order to be able to remove condensate water accumulating there from an evaporator of the air-conditioning system.

There is a constant need to make dehumidifying an air-conditioning system simple and efficient.

### SUMMARY

The object of the invention is to show measures that enable simple and efficient dehumidification of an air-conditioning system.

The object is achieved according to the invention by an air-conditioning system and a method. Preferred embodiments of the invention are specified in the following description, which may each individually or in combination represent an aspect of the invention.

One aspect of the invention relates to an air-conditioning system, in particular for the climate control of an interior of a motor vehicle, having a fan for conveying drawn-in air through an air duct and an evaporator provided in the air duct for cooling the drawn-in air, wherein a collecting body separate from the air duct, for collecting air humidity of the drawn-in air condensing at the evaporator is provided in the air duct, wherein, in the deactivated state of the evaporator, the drawn-in air is able to flow against and/or around the collecting body.

The fan can draw in air from the environment, wherein the drawn-in air can be warm and humid depending on the environmental conditions. This allows the humidity of the air that is drawn-in and cooled by the evaporator to condense on the cold evaporator. This condensate can drip off the evaporator under the influence of gravity. The collecting body can collect this dripping condensate and store it at least temporarily. This prevents condensate from accumulating at the lowest point in the air duct. This takes advantage of the finding that condensate collecting at the lowest point of the air duct usually forms a very small surface area, which means that only a small mass flow of the condensate can be removed by the air flow provided by the fan running on. In addition, the air duct is usually designed in such a way that flow resistance is minimized, so that the flow conditions on the duct wall of the air duct are rather unfavorable for the absorption of the condensate.

With the help of the collecting body separate from the air duct, the condensate can be collected at a distance from the duct wall of the air duct, whereby the condensate can be flowed against with more favorable flow conditions. The collecting body may be adjacent to the evaporator. Preferably, the collecting body is spaced apart from the evaporator so that the condensate can drip from the evaporator via a thermally insulating air gap between the evaporator and the collecting body and impinge on the collecting body. Particularly preferably, the collecting body can be designed to distribute the condensate over a larger surface area than that resulting from a semicircular channel. The collecting body thus makes it possible to bring the collected condensate into contact with the air flow generated by the fan over a significantly larger surface area and under significantly better flow conditions, resulting in a considerably increased mass flow into the air flow and a greater loading of the air flow with the collected condensate. This in turn allows the air-conditioning system, especially the air duct, to dry faster and requires less power from the fan. This improves the energy efficiency for dehumidifying the air-conditioning system. Since only a suitably designed and shaped collecting body needs to be positioned at a location where the drawn-in air can flow against or around it, in particular below the evaporator, this energy saving can be achieved very easily in terms of construction. For example, the collecting body can be easily replaceably inserted into a holder that projects into the interior of the air duct, so that the collecting body in particular can be flowed around at a plurality of surfaces. The collecting body positioned within the air duct can improve the discharge of condensate forming on the evaporator, thus enabling simple and efficient dehumidification of an air-conditioning system.

The air-conditioning system may in particular have a closed cooling circuit in which the evaporator is provided. The cooling circuit may have a compressor to circulate a refrigerant in the cooling circuit. The refrigerant compressed by the compressor can be cooled in a heat exchanger or cooler, in particular a front cooler of the motor vehicle, and subsequently fed to the evaporator via an expansion valve. The evaporated refrigerant can then be fed back into the compressor and liquefied. The fan can direct the drawn-in air along surfaces of the evaporator, which can cool the drawn-in air. The cooled air can then be directed into the interior of the motor vehicle.

The air duct can lead from an inlet communicating with the environment via the fan to at least one outlet. An outlet leading to the interior of the motor vehicle can be provided in order to air-condition the interior with the help of the conditioned air. The air duct can also lead to a further outlet communicating with the environment to remove unused air and to discharge condensate carried by the drawn-in air, thereby dehumidifying the air-conditioning system. Preferably, switching elements are provided with the aid of which the mass flow and/or the flow direction of the air flow directed into the interior can be adjusted. In particular, it can be provided that the air flow drawn-in by the fan is guided over different flow paths with the aid of the at least one switching element.

In particular, the collecting body has a plurality of storage pores for the temporary storage of condensing air humidity. The collecting body can be unevenly shaped to form the storage pores and can deviate significantly from the shape of a bowl. This allows the collected condensate to be distributed across the plurality of pores. Due to the surface tension of the condensate, the water absorbed in the respective pore can be retained in the pore, preventing the condensate from dripping to the bottom of the air duct. At the same time, a large total surface area for the collected condensate can be formed via the pores, which improves a phase transition from the pore into the air flow generated by the fan and enables a high loading of the air flow with the condensate.

Preferably, the collecting body is designed as a sponge and/or foam. The collecting body can be made of a natural and/or a synthetic material. For example, the collecting body is designed as an aluminum foam. The collecting body can therefore easily form a plurality of pores and/or provide a large surface area for the collected condensate.

Particularly preferably, the collecting body can be flowed against by the drawn-in air on a bottom side pointing downwards in the direction of gravity and/or on a top side pointing downwards in the direction of gravity and/or on at least one side surface pointing substantially in a horizontal direction. The collecting body can in particular be positioned substantially centrally in a flow cross-section of the air flow provided by the fan. Since the collecting body is preferably not only flowed against on one side, but can even be flowed around on surfaces facing away from each other, a particularly large mass flow of condensate can be transferred from the collecting body to the air flow.

In particular, the fan is coupled to the evaporator via a timer relay with a predetermined delay time in such a way that the fan starts with a delay equal to the delay time after the evaporator is deactivated. This prevents the fan from actively running after the fan has phased out to a stop. Instead, the delay time can be used to wait for the evaporator surfaces to be sufficiently close to the ambient temperature so that no significant condensate production on the evaporator surfaces is to be expected when the fan draws in unconditioned air. The condensate can be retained in the collecting body over the duration the delay time. The operating time of the fan after the delay time required to dehumidify the air-conditioning system can thus be minimized, so that the associated energy consumption can also be minimized.

Preferably, the fan can be switched off depending on the water load of the collecting body and/or after a predetermined drying time has elapsed. For example, the fan can be operated until a humidity sensor indicates a sufficiently low condensate load in the collecting body, thus signaling sufficient dehumidification of the air-conditioning system. The fan can be switched off in response to a measurement signal from the humidity sensor. Additionally or alternatively, the fan is switched off after the predetermined drying time. In particular, if the desired drying of the collecting body, as measured by the humidity sensor, cannot be achieved within the drying time in particularly warm and humid weather conditions, unnecessarily long and inefficient operation of the fan can be avoided.

Particularly preferably, the collecting body is arranged in a bypass duct that can be closed off from the rest of the air duct. This allows the air drawn-in by the fan to flow around the evaporator but not the collecting body during normal air-conditioning operation. This prevents unwanted humidity accumulation in the air supplied to the interior of the motor vehicle. When the evaporator of the air-conditioning system and/or of the motor vehicle is switched off, the air drawn-in by the fan can be directed into the bypass duct, wherein the drawn-in air is led around the evaporator, which may still be quite cold. In this dehumidification mode of the air-conditioning system, an outlet leading to the interior can be closed so that the particularly humid air, after flowing around the collecting body, can be discharged past the interior to the environment.

In particular, the collecting body is positioned at a distance from a duct wall of the air duct. Contact of the condensate with a duct wall of the air duct can thus be avoided, so that wear effects caused by the presence of water, for example water corrosion on metallic components, can also be avoided. In addition, the drawn-in air can flow around the collecting body on an as wide as possible surface area.

A further aspect of the invention relates to a method for operating an air-conditioning system, which can be designed and developed as described above, in which, after deactivating the evaporator, in particular after switching off the motor vehicle, the fan is operated in order to dry the collecting body loaded with condensing air humidity with the aid of the air drawn-in by the fan and to discharge the condensing air humidity from the air-conditioning system. The method can be designed and developed in particular as described above with reference to the air-conditioning system. The collecting body positioned within the air duct can improve the discharge of condensate produced on the evaporator, thus enabling simple and efficient dehumidification of an air-conditioning system.

Preferably, the fan is started after a predetermined delay time from the deactivation of the evaporator and/or from the switching off of the motor vehicle. This prevents the fan from actively running after the fan has phased out to a stop. Instead, the delay time can be used to wait for the evaporator surfaces to be sufficiently close to the ambient temperature so that no significant condensate production on the evaporator surfaces is to be expected when the fan draws in unconditioned air. The condensate can be retained in the collecting body over the duration of the delay time. The operating time of the fan after the delay time required to dehumidify the air-conditioning system can thus be minimized, so that the associated energy consumption can also be minimized.

### BRIEF DESCRIPTION OF THE FIGURE(S)

The invention is explained below by way of example with reference to the attached drawings using a preferred exemplary embodiment, wherein the features shown in the following can represent an aspect of the invention both individually and in combination. In the figures:

FIG. 1 shows a schematic sectional view of part of an air-conditioning system.

### DETAILED DESCRIPTION

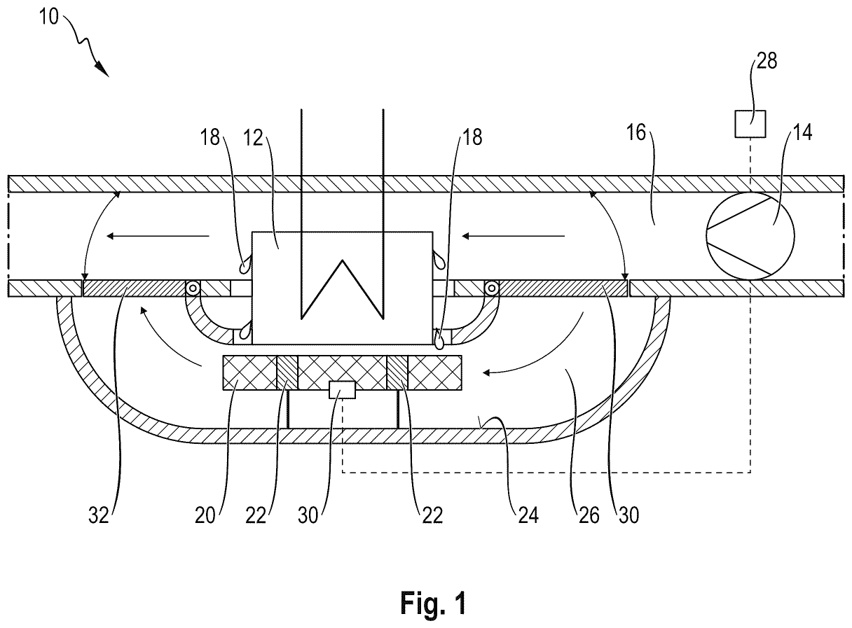

The air-conditioning system 10, which is only partially shown in FIG. 1, can be used to air condition an interior of a motor vehicle. The air-conditioning system 10 has an evaporator 12 in which a refrigerant can be evaporated to generate cold. As a result, an air flow drawn-in by a fan 14 from the environment via an air duct 16 can be cooled in normal air-conditioning operation of the air-conditioning system 10 before the air flow reaches the interior of the motor vehicle. Condensate 18 forming on the evaporator 12 can drip down on the surfaces of the evaporator 12 due to gravity and impinge on a collecting body 20, which is designed, for example, as a sponge or metal foam. The collecting body 20 can collect the condensate 18 and store it at least temporarily, in particular in pores of the collecting body 20. The collecting body 20 is positioned by means of holders 22 at a distance from a duct wall 24 of a bypass duct 26 connected to the remaining air duct 16 and is positioned essentially centrally relative to a flow cross-section of the bypass duct 26 of the air duct 16.

When the motor vehicle and/or the evaporator 12 are switched off or deactivated, the fan 14 can be switched on again after a delay time which can be specified by means of a timer relay 28. During the delay time, the bypass duct 26 can be opened, for example with the aid of at least one switching flap 30 of a switching element, and preferably a large part of the evaporator 12 can be shielded from the air flow. In this dehumidification operation, the air flow can flow around the collecting body 20 over as large a surface area as possible in order to be able to collect as much condensate 18 as possible from the collecting body 20 and discharge it into the environment. The fan 14 can be switched off automatically after a predetermined drying time and/or when the humidity or water load of the collecting body 20 is sufficiently low, which can be measured by means of a humidity sensor 32.

1-10. (canceled)

11. An air-conditioning system, in particular for the climate control of an interior of a motor vehicle, comprising:
a fan for conveying drawn-in air through an air duct;
an evaporator provided in the air duct for cooling the drawn-in air; and
a collecting body, separate from the air duct, for collecting air humidity, condensed at the evaporator, of the drawn-in air is provided in the air duct, wherein, in the deactivated state of the evaporator, the drawn-in air is able to flow against and/or around the collecting body.

12. The air-conditioning system according to claim 11, wherein the collecting body has a plurality of storage pores for temporarily storing the condensing air humidity.

13. The air-conditioning system according to claim 11, wherein the collecting body is designed as a sponge and/or foam.

14. The air-conditioning system according to claim 11, wherein the drawn-in air can flow against the collecting body on a bottom side pointing downwards in the direction of gravity and/or on a top side pointing downwards in the direction of gravity and/or on at least one side surface pointing substantially in a horizontal direction.

15. The air-conditioning system according to claim 11, wherein the fan is coupled to the evaporator via a timer relay with a predetermined delay time such that the fan starts with a delay equal to the delay time after a deactivation of the evaporator.

16. The air-conditioning system according to claim 15, wherein the fan can be switched off depending on a water load of the collecting body and/or after a predetermined drying time has elapsed.

17. The air-conditioning system according to claim 11, wherein the collecting body is arranged in a bypass duct which can be closed off from the remaining air duct.

18. The air-conditioning system according to claim 11, wherein the collecting body is positioned at a distance from a duct wall of the air duct.

19. A method for operating an air-conditioning system according to claim 11, in which, after deactivation of the evaporator, in particular after switching off the motor vehicle, the fan is operated in order to dry the collecting body loaded with condensing air humidity with the aid of the air drawn-in by the fan and to discharge the condensing air humidity from the air-conditioning system.

20. The method according to claim 19, in which the starting of the fan is carried out after a predetermined delay time from the deactivation of the evaporator and/or from the switching off of the motor vehicle.

21. The air-conditioning system according to claim 12, wherein the collecting body is designed as a sponge and/or foam.

22. The air-conditioning system according to claim 12, wherein the drawn-in air can flow against the collecting body on a bottom side pointing downwards in the direction of gravity and/or on a top side pointing downwards in the direction of gravity and/or on at least one side surface pointing substantially in a horizontal direction.

23. The air-conditioning system according to claim 3, wherein the drawn-in air can flow against the collecting body on a bottom side pointing downwards in the direction of gravity and/or on a top side pointing downwards in the direction of gravity and/or on at least one side surface pointing substantially in a horizontal direction.

24. The air-conditioning system according to claim 12, wherein the fan is coupled to the evaporator via a timer relay with a predetermined delay time such that the fan starts with a delay equal to the delay time after a deactivation of the evaporator.

25. The air-conditioning system according to claim 13, wherein the fan is coupled to the evaporator via a timer relay with a predetermined delay time such that the fan starts with a delay equal to the delay time after a deactivation of the evaporator.

26. The air-conditioning system according to claim 14, wherein the fan is coupled to the evaporator via a timer relay with a predetermined delay time such that the fan starts with a delay equal to the delay time after a deactivation of the evaporator.

27. The air-conditioning system according to claim 12, wherein the collecting body is arranged in a bypass duct which can be closed off from the remaining air duct.

28. The air-conditioning system according to claim 13, wherein the collecting body is arranged in a bypass duct which can be closed off from the remaining air duct.

29. The air-conditioning system according to claim 14, wherein the collecting body is arranged in a bypass duct which can be closed off from the remaining air duct.

30. The air-conditioning system according to claim 15, wherein the collecting body is arranged in a bypass duct which can be closed off from the remaining air duct.
